(19) United States
(12) Patent Application Publication
(10) Pub. No.: US 2022/0023772 A1
(43) Pub. Date: Jan. 27, 2022

(54) SOLVENT-FREE LOW PRESSURE EXTRACTION OF PLANT COMPOUNDS

(71) Applicant: Atlas Bimetals Labs, Inc., Port Townsend, WA (US)

(72) Inventors: Richard Dennis Bothell, Sequim, WA (US); Justin Chase Bothell, Port Townsend, WA (US); Todd Kristian Hansen, Silverdale, WA (US); Timothy David Humiston, Sequim, WA (US)

(73) Assignee: Atlas Bimetals Labs, Inc., Port Townsend, WA (US)

(21) Appl. No.: 17/443,821

(22) Filed: Jul. 27, 2021

Related U.S. Application Data
(60) Provisional application No. 63/057,195, filed on Jul. 27, 2020.

(51) Int. Cl. B01D 11/02; B01D 5/00

(52) U.S. Cl. CPC B01D 11/0288; B01D 11/0215; B01D 5/0057; B01D 11/0284; B01D 11/0296

(57) ABSTRACT

Systems and methods for solvent-free direct extraction of target compounds from plant matter are disclosed herein. The disclosed systems and methods use low pressure to reduce the evaporation temperature of target compounds without affecting the chemical integrity thereof. Target compounds are extracted from the plant matter in an evacuation chamber, and the extracted target compounds are then collected using a cooling system. Target compounds may be drawn from the evacuation chamber into the cooling system using a carrier gas to facilitate transport of the targeted compounds in the vapor phase. The evaporated target compounds may, for example, be drawn into the cooling system using a recirculation system that includes a blower. The disclosed systems and methods may be used, for example, to extract target compounds from plant matter such as fresh or dried cannabis and hemp, lavender, rosemary, lilac, or other suitable plant matter containing desirable compounds for extraction.

### CROSS-REFERENCE TO RELATED APPLICATIONS

This application claims the benefit of and priority to U.S. Provisional Patent Application Ser. No. 63/057,195, filed on Jul. 27, 2020, the entirety of which is hereby incorporated herein by reference.

### BACKGROUND

### Field of the Invention

The present disclosure relates to methods of extraction of compounds from natural products.

### Description of the Related Art

Medicinal compounds in plants may be extracted for use in specific applications where the influence of other compounds within the plant is undesirable. Conventional methods of extracting such medicinal compounds use solvents. However, the solvent needs to be removed from the extracted plant medicinal crude oils prior to use of the medicinal compounds. Undesirable trace amounts of solvents invariably remain, and solvent removal techniques may also remove many desirable compounds. Known extraction techniques that do not use solvents are typically limited, and are frequently unable to extract all of the desired compounds or alternatively will extract undesirable compounds along with the compounds of interest. Other extraction techniques require temperatures that are so high that the target medicinal extracts are chemically altered or destroyed.

For example, solvent-based extraction of cannabis and hemp plant matter has numerous limitations. Known extraction methods use one or more solvents to dissolve cannabinoids contained in the plant matter. The methods are significantly more effective when dried cannabis or hemp plant matter is used as a precursor. Logistically, drying may take several days and require a very significant amount of space. Drying also almost always results in a loss of many terpenes. These terpenes are volatile organic compounds that evaporate with water as the plant matter dries. Solvents used include hydrocarbons such as butane or alternatively alcohols. Cannabinoids and the remaining terpenes dissolve in the solvent and are essentially rinsed out of the plant matter with the solvent. The solvent may subsequently be removed using vacuum. At least a small amount of solvent invariably remains after the initial vacuum removal thereof, and high temperature processing is often required to remove the residual solvent. This is particularly the case when alcohol solvents are used, on account of the typically higher boiling points of alcohols as compared to comparable molecular weight hydrocarbons. Moreover, the solvents typically used are highly flammable, and thus arduous engineering and safety processes must be implemented. Use of alcohol solvents also leads to the extraction of chlorophyll, an undesirable contaminant in many extracts.

Alternatively, supercritical carbon dioxide (CO₂) may be used as a solvent for extraction. However, this method requires plant matter to be dried and ground into a fine powder prior to extraction. In addition, supercritical CO₂ processes frequently result in the degradation of terpenes. Thus, the use of supercritical CO₂ is suboptimal for extraction where the target compounds include terpenes that may be degraded by the use thereof. In addition, supercritical CO₂ processes require the use of equipment capable of withstanding very high pressures, which increases both costs and risks to safety. In addition, the high pressure required limits in practice the diameter of extraction equipment, and thereby limits batch volume.

Steam distillation is a common industrial extraction technique. It is not however commonly used in the cannabis industry because it does not remove cannabinoids efficiently. Steam distillation uses high temperature steam to infuse plant matter and carry the target compounds out of the plant matter to a condenser. Vacuum is not used in this technique and the high temperatures alter the quality of the extracts.

Vacuum is used industrially for distillation but is generally limited in scope to purification of oils that have already been extracted. Vacuum is typically not used to extract crude oils or target compounds directly from plant matter.

For example, short path distillation techniques are commonly used to separate one compound from a crude oil mixture containing two or more oils. Conventional short path techniques use an evenly heated crude mixture which is often a spinning flask in a bath of heated water or oil. This is known as a rotary evaporator. The flask is evacuated and the evaporated compounds are vacuum pumped to a condenser section of the apparatus. The condenser is also temperature controlled so as to select one compound from the vapor stream by differential condensation.

Another variant of the short path distillation technique employs vacuum and a heated spinning disc. The disc is heated in vacuum and spun so that it centrifugally spreads oils. The low aspect ratio of precisely heated oils facilitates evaporation of target distillates which condense on a cold plate positioned near the rotating disc. The remaining compounds are wiped from the disc at the circumference. There are other variants of these forms of vacuum distillation, but all use pre-extracted crude mixtures as a precursor. These techniques do not extract crude mixtures directly from plant matter.

U.S. Patent Application Publication No. 2019/0299115 discloses a solvent-free method of extracting phytochemicals from plant matter that uses vacuum. Ahmad, et al. disclose a solvent-free method of extracting essential oils from plant matter. Ahmad, M. S., et al. “Novel Closed System Extraction of Essential Oil: Impact on Yield and Physical Characterization,” Intl Conf. Biotechnol. Environ. Manag., 2014, 75, 42-46. U.S. Patent Application Publication No. 2004/0147767 discloses a method of extracting compounds from plant matter using heated gas. U.S. Patent Application Publication No. 2019/0366231 discloses a solvent-free method of extracting oils from plant matter that uses a centrifugal electrostatic precipitator. Each of these methods have limitations that may limit the utility thereof.

Thus, there remains a need for a solvent-free system and method of extraction that is capable of extracting target medicinal compounds from plants that does not alter the target compounds or contaminate the target compounds with undesirable byproducts.

### SUMMARY

Systems and methods for solvent-free direct extraction of target compounds from plant matter are disclosed herein. The disclosed systems and methods use low pressure to reduce the evaporation temperature of target compounds without affecting the chemical integrity thereof. Target compounds are extracted from the plant matter in an evacuation chamber, and the extracted target compounds are then collected using a cooling system. Target compounds may be drawn from the evacuation chamber into the cooling system using a carrier gas to facilitate transport of the targeted compounds in the vapor phase. The evaporated target compounds may, for example, be drawn into the cooling system using a recirculation system that includes a blower. The disclosed systems and methods may be used, for example, to extract target compounds from plant matter such as fresh or dried cannabis and hemp, lavender, rosemary, lilac, or other suitable plant matter containing desirable compounds for extraction.

Target compounds are extracted from plant matter by subjecting the plant matter to vacuum. The target compounds are vaporized within an evacuation chamber, and are then transported as a vapor stream into a cooling system and a desired amount of the target compounds are condensed from the vapor stream within the cooling system. The cooling system may preferably include one or more condensers. The plant matter may optionally be gently heated under vacuum to further facilitate extraction. A recirculation system may optionally be used to facilitate transport of the target compounds.

In some embodiments, the plant matter may be fresh plant matter that is not pre-dried or frozen prior to extraction. The plant matter may optionally be mechanically lysed prior to extraction.

Each of the foregoing and various aspects, together with those set forth below and summarized above or otherwise disclosed herein, including the figures, may be combined without limitation to form claims for a device, apparatus, system, method of manufacture, and/or method of use.

### BRIEF DESCRIPTION OF THE DRAWINGS

FIG. 1 shows an embodiment of the disclosed system.

FIG. 2 shows an exploded view of the evacuation chamber of the embodiment shown in FIG. 1.

FIG. 3 shows an exploded view of the cooling system of the embodiment shown in FIG. 1.

FIG. 4 shows an exploded view of a blower chamber that forms part of the recirculation system of the embodiment shown in FIG. 1.

FIG. 5 shows an exploded view of a heat exchange chamber that forms part of the recirculation system of the embodiment shown in FIG. 1.

### DETAILED DESCRIPTION OF THE ILLUSTRATED EMBODIMENTS

Systems and methods for solvent-free direct extraction of target compounds from plant matter are disclosed herein. The disclosed systems and methods use low pressure to reduce the evaporation temperature of target compounds without affecting the chemical integrity thereof. Target compounds are extracted from the plant matter in an evacuation chamber, and the extracted target compounds are then collected using a cooling system. Target compounds may be drawn from the evacuation chamber into the cooling system using a carrier gas to facilitate transport of the targeted compounds in the vapor phase. The evaporated target compounds may, for example, be drawn into the cooling system using a recirculation system that includes a blower. The disclosed systems and methods may be used, for example, to extract target compounds from plant matter such as fresh or dried cannabis and hemp, lavender, rosemary, lilac, or other suitable plant matter containing desirable compounds for extraction.

Target compounds are extracted from plant matter by subjecting the plant matter to vacuum. The target compounds are vaporized within an evacuation chamber, and are then transported as a vapor stream into a cooling system and a desired amount of the target compounds are condensed from the vapor stream within the cooling system. The cooling system may preferably include one or more condensers. The plant matter may optionally be gently heated under vacuum to further facilitate extraction. A recirculation system may optionally be used to facilitate transport of the target compounds.

In some embodiments, the plant matter may be fresh plant matter that is not pre-dried or frozen prior to extraction. The plant matter may optionally be mechanically lysed prior to extraction.

In some preferred embodiments, plant matter may be fresh cannabis or hemp that is not pre-dried. In such embodiments, the plant matter may be heated under vacuum to a temperature of between about 50-200° C., preferably between about 140-190° C., more preferably between about 150-185° C., and even more preferably between about 170-180° C. The vacuum may be between about 0.001-100 torr, preferably between about 0.01-20 torr, and more preferably between about 0.1-10 torr. The target compounds may include cannabinoids and terpenes. The target compounds may be transported from the evacuation chamber to the cooling system by diffusion or optionally by drawing the target compounds into the cooling system using a blower. The blower may preferably be part of a recirculation system. An appreciable amount of the vaporized target compounds will condense within the cooling system and will accumulate as one or more condensates. The condensates may include a full spectrum of cannabinoid and terpene crude oil extracts that are not contaminated by solvents. Specific target compounds may be isolated if a cooling system with multiple condensers maintained at different temperatures is used. The total amount of target compounds that will condense within the cooling system and where various fractions will condense within the cooling system may be fine-tuned as described below. The fine-tuning also minimizes the amount of undesirable compounds, such as chlorophyll and waxes, within the condensates, and these amounts will preferably be negligible.

The disclosed systems and methods yield extracts that are more pure and that contain more desirable compounds and fewer undesirable compounds than previously disclosed systems and methods for extraction of compounds from plant matter.

### Recirculation System

In some embodiments, a recirculation system may be used to facilitate transport of target compounds into the cooling system. Use of a recirculation system may increase the yield of target compounds and may also increase the rate of condensation of target compounds within the cooling system. Use of a recirculation system will increase the mass transfer rate from the plant matter to the cooling system.

The recirculation system may include one or more blowers proximate to the evacuated plant matter. The one or more blowers are used to direct a vapor stream that includes a carrier gas and may also include a small amount of target compounds, as described below, into the evacuation chamber. The vapor stream that includes the carrier gas will become saturated or substantially saturated with target compounds in the evacuation chamber. The saturated or substantially saturated vapor stream will exit the evacuation chamber via an outlet and flow toward the cooling system. This will direct the flow of evaporated target compounds from the evacuation chamber toward the cooling system. The flow rate and composition of the carrier gas will determine, at least in part, whether the carrier gas will be saturated by target compounds before it is transported into the cooling system. In some embodiments, the carrier gas may be air.

The blowers may be housed within the evacuation chamber or within one or more blower chambers within the recirculation system. The blower chambers may be positioned at various locations within the recirculation system, such as between the outlet from the evacuation chamber and an inlet into the cooling system, or alternatively after an outlet from the cooling system and before an inlet into the evacuation chamber. Multiple blowers positioned at different locations within the recirculation system may be used. Each blower chamber may house one or more blowers.

When the carrier gas and the target compounds contained therein enter the cooling system, a significant percentage of the target compounds will be condensed by one or more condensers to form condensates, as described in more detail below. Following condensation, the carrier gas will contain a significantly smaller quantity of target compounds. In some embodiments, this unsaturated carrier gas is recirculated and reintroduced into the evaporation chamber.

Because the carrier gas is substantially unsaturated when it is reintroduced into the evaporation chamber, more target compounds are volatilized and re-saturate the carrier gas stream. The saturated carrier gas then reenters the cooling system, where condensation of the target compounds occurs. This process may be repeated several times to maximize the yield of target compounds.

It has been determined that recirculation of the carrier gas significantly increases the rate of mass transfer. As the mass transfer rate is already high under vacuum compared to atmospheric pressure, it would not be expected that use of a carrier gas would provide further improvement in the mass transfer rate. Rather, introduction of a carrier gas will increase the pressure, and would thus be expected to reduce the mass transfer rate. In addition, a forced gas recirculation convection system is typically more effective at high pressures, such as pressures at or above atmospheric pressure. See, e.g., U.S. Patent Application Publication No. 2004/0147767.

### Cooling System

The cooling system may preferably include one or more condensers. In some preferred embodiments, multiple condensers may be used. The condensers may be positioned in the vapor flow path, where each successive downstream condenser may be held at a lower temperature than the adjacent upstream condenser. The least volatile target compounds will condense at the condenser that is furthest upstream. Each successive downstream condenser will condense more volatile compounds. As the vapor flow progresses downstream toward the lower temperature condensers, the most volatile target compounds will begin to condense. As a result, the target compounds collected at each condenser will be fractionated by volatility. Each fraction will condense at the first condenser that has a temperature at or below the condensation temperature of that fraction under the conditions of the system. Compounds within the vapor stream that condense at temperatures below that of the target condenser will remain in vapor form and will not condense at the target condenser.

For example, with respect to the extraction of cannabinoids and terpenes from cannabis or hemp plant matter, specific cannabinoids and terpenes will be selectively removed from the vapor stream within specific condensation zones within the cooling system. For example, cannabidiol (CBD) may be selectively removed from the vapor stream by first removing cannabinol (CBN) and Δ-8-tetrahydrocannabinol (THC-8) with a condenser operating at 87° C. at 5-10 torr. Since CBN and THC-8 have condensation temperatures of approximately 100° C. and 92° C. respectively at that pressure, both compounds will condense at this condenser while CBD will remain in the vapor phase without condensing. CBD may then be collected at a downstream condenser held at approximately 85° C. at 5-10 torr. Δ-9-tetrahydrocannabinol (THC-9) and terpenes such as α-pinene will remain in the vapor stream without condensing, since they have a lower condensation temperature of roughly 72° C. and 71° C. respectively at 5-10 torr. Terpenes may be selectively condensed using an analogous method.

By using a relatively low vacuum (i.e., a relatively high pressure), a larger quantity of target compounds may be transported in the vapor stream.

In some embodiments, the system may further comprise one or more valves or gates to direct the flow of the vapor stream toward specific condensers within the cooling system. The valves or gates may be selectively actuated to cause the vapor stream to remain in the area of a specific condenser for a specified period of time that maximizes condensation of the target compounds for that condenser without condensing other compounds that are not targeted for condensation at that condenser. For example, target compounds that condense at relatively high temperatures may be more thoroughly removed from the vapor stream by preventing the vapor stream from flowing toward lower temperature downstream condensers by closing appropriate valves or gates until the targeted compounds for the higher temperature condensers have been substantially removed from the vapor stream. The vapor stream may be recirculated to flow over the higher temperature condensers until the desired amount of target compounds have been condensed. This may be accomplished using recirculation ducts that force the vapor stream to flow over the higher temperature condensers multiple times until the valve or gate that prevents flow toward the lower temperature condensers is opened. A valve or gate may then close the recirculation duct to force the vapor stream to flow toward the next lower temperature condenser. By using valves or gates and recirculation ducts for each successively lower temperature condenser, the condensation of target compounds at each condenser may be optimized.

The disclosed system may allow a target condenser to be held at temperatures that are not substantially below the condensation temperature of the targeted compounds for that condenser. For example, it may be sufficient to hold the target condenser at a temperature that is approximately 5° C. lower than the condensation temperature of the target compounds for that condenser. This enhances separation between the various target compound fractions. Heat may be dissipated using cooling fans, which may obviate the need for a refrigeration system as a component of the cooling system.

In some alternate embodiments, a single condenser that includes a variable heater may be used. The condenser is held at a temperature that is sufficiently low to condense substantially all of the target compounds. The condenser is then slowly heated to release comparatively more volatile target compounds as oils. As the condenser is slowly heated, distinct fractions of oils will flow off the condenser for separation. More viscous oils will require higher temperatures to flow, and thus by gradually heating the condenser distinct fractions of target compounds may be separated.

### Heating System

In some embodiments, plant matter may be heated under vacuum using a heating system. The heating system may be configured to progressively heat the plant matter. As the plant matter is heated, various target compounds will vaporize and may be condensed using the cooling system in the order in which they are volatilized. This further enhances separation between target compounds. For example, for extraction of target compounds from cannabis or hemp plant matter, the plant matter may be ultimately heated under vacuum to a temperature of between about 50-200° C., preferably between about 140-190° C., more preferably between about 150-185° C., and even more preferably between about 170-180° C.

The heating system may be used with or without a recirculation system. If a recirculation system is used in conjunction with a heating system, the carrier gas used in the recirculation system may also act as a heat source, where a pre-heated carrier gas transfers heat to the plant matter.

### Wiper System

The viscosity of target compounds may be temperature dependent. Thus, in some embodiments, a wiper system may be used to direct viscous target compounds away from the condenser such that additional target compounds may be more readily condensed. The wiper system may preferably be a mechanical wiper system.

### Fluid-Like Transfer Medium

In some embodiments, a fluid-like transfer medium may be used to enhance the heat transfer rate. Since vapor density is reduced in vacuum, the convective capacity of the rarified gas for heat transfer is reduced. By including a fluid-like medium such as sand or metallic beads in the evacuation chamber, the heat transfer rate to the plant matter may be increased. The fluid-like medium may increase conductive contact and may also allow mixing of the plant matter in the fluid-like medium to further enhance heat transfer.

In some alternate embodiments, a fluidized bed may be used. The plant matter may be mixed with the solid material of the bed and the mixture may be fluidized using a highly diffuse hot gas stream applied from below the mixture. This enhances conductive heat transfer and also removes target compounds as part of a vapor stream that flows through the fluidized bed.

### Plant Matter Preparation

In some preferred embodiments, the plant matter may be lysed prior to volatilization. The lysing may preferably be performed under vacuum. In some embodiments, the lysing may preferably be performed using a blender or grinder. The plant matter may thus form a slurry, which offers superior heat transfer properties.

In some embodiments, the slurry may be placed in one or more basins within the evacuation chamber. The basins may be rotated or stirred to increase thermal transfer and thereby increase the evaporation rates of target compounds. The slurry may be heated within the one or more basins using one or more heaters such as resistive heaters.

In some alternate embodiments, a rotating head drum may agitate the slurry as it dries.

In other alternate embodiments, a heated evacuated tube and auger may be used to stir the slurry as it dries and longitudinally purge the slurry with the carrier gas.

In yet other alternate embodiments, the slurry may be placed in a finely meshed basket and spun at high velocity to remove water and oils using centrifugal forces. This allows mechanical removal of water and oils both quickly and with little evaporative energy expenditure. The oils may then be extracted from the liquid mixture using the extraction techniques disclosed herein. The slurry may be frozen and stored without degradation for an indefinite period, for example until such time as extraction equipment is available.

### Plant Matter Processing

Once adequate heat and vacuum are applied to a slurry of freshly lysed plant matter, the slurry will boil. This will remove excess water and some terpenes. In some preferred embodiments, the slurry will be heated to approximately 70° C. at approximately 233 torr. Numerous other temperatures and pressures may alternatively be used.

The cooling system may include multiple condensers held at temperatures lower than the temperature of the heated slurry. Water is removed from the system by condensing it as a liquid rather than removing it as water vapor. This allows use of a smaller vacuum pump than would be required if water was removed as water vapor. For the processing of cannabis or hemp plant matter, most cannabinoids are not removed at this step, as they require higher temperatures or higher vacuum to evaporate. High vacuum is impossible to achieve until most of the water is removed from the system due to its high vapor pressure.

In embodiments that include multiple condensers, it has been found that the system operates highly efficiently if the first condenser is held at approximately 20° C. This lowers the saturated water vapor pressure at the condenser to 17.5 torr. Thus, if the slurry is heated to 70° C. at approximately 233 torr as described above, approximately 215.5 torr of water vapor will be removed at this condenser. This is a 92.5% reduction of water vapor, which is highly efficient for a system that does not require mechanical pumping or refrigeration. The water and terpene condensate mixture may simply be removed from the vacuum system with a peristaltic pump or similar water pump when the water accumulation merits draining. The terpenes are insoluble in water and less dense, and thus form a layer on the top of the water that may easily be removed.

Once the vapor stream flows past the first condenser, it is then directed toward one or more condensers that are held at lower temperatures. The temperature of these subsequent condensers may be as low as cryogenic temperatures (<−150° C.). In some embodiments, the next lower temperature condenser is held at slightly above the freezing point of water under the conditions so that the remaining water can be removed as a liquid. If a −15° C. condenser is used this will remove another 92% of the remaining water vapor. The use of multiple condensers allows for 99.3% of the water to be removed from the system as a liquid without requiring mechanical pumping and allows for nearly all terpenes to be collected.

It has been found that using lower temperature (−60° C.) and cryogenic (liquid nitrogen) temperature condensers further downstream allows for extraction of nearly all the terpenes from the vapor stream. This is particularly useful once most of the water vapor has been removed using higher temperature upstream condensers. It has been found that the terpenes will emulsify if a significant amount of water is present at the cryogenic condensers.

After most of the water is removed from the slurry the temperature of the remaining product may be increased up to the ideal extraction temperature, which is approximately 170° C. for cannabinoids. The vacuum may also be increased to approximately 5 torr.

### Microcontroller

In some preferred embodiments, a microcontroller may be used to control process variables such as vacuum pressure, heating system temperature, the temperature of the condensers, the recirculating blower, the vacuum pump and various water pumps, wipers, and level sensors. Further, the microcontroller may be accessed via a user interface on a computer or smartphone. The user interface may preferably provide information regarding system parameters and error notification.

The microcontroller allows monitoring of the process variables so as to optimize the process for each phase. For example, since wet plant matter will only allow a specific vacuum pressure to be obtained based on the vapor pressure of the plant matter, it is possible to determine when the plant matter has dried. The microcontroller may therefore reliably detect this point and add a more measured quantity of heat may be applied to the plant matter to avoid overheating.

### Minimizing Oxidation of Target Compounds

For extractions where target compounds may be susceptible to oxidation, such as for the extraction of cannabinoids and terpenes from cannabis or hemp plant material, an inert atmosphere may be used to reduce the partial pressure of oxygen in the vapor stream. This may be achieved by evacuating or flushing the air from the system using argon, helium, nitrogen, or carbon dioxide. Once a suitably high vacuum is obtained, an inert gas may be streamed back into the system. As the pressure of the inert gas rises, the streaming of the inert gas is stopped and the system is re-evacuated and the cycle is repeated. An inert gas may also be leaked into the system so as to direct the vapor stream toward the condensers.

The inert gas reduces the oxidization of target compounds such as cannabinoids and may also improve quality of the target compounds.

Additional process gases may also be added to the system to chemically treat the target compounds as they are extracted. For example a high partial pressure of CO₂ will reduce the proclivity of Δ-8-THC to decarboxylate. Since decarboxylated Δ-9-THC is psychoactive, this system may be used to prevent the psycho-activation of THC.

### Illustrative Example

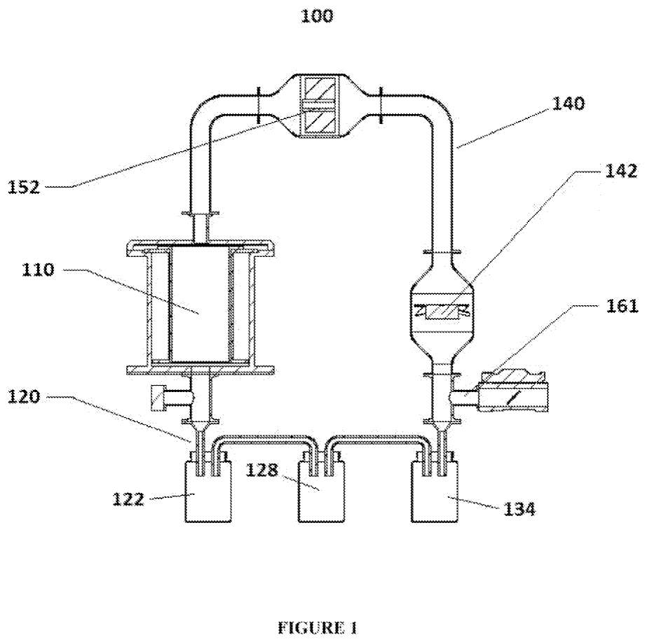

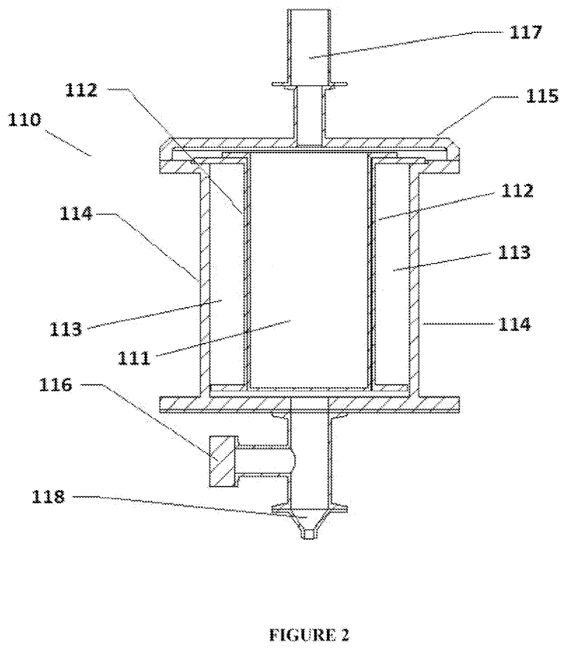

FIG. 1 shows an embodiment 100 of the disclosed system, and FIGS. 2-5 show exploded views of components of the embodiment 100.

FIG. 1 shows an embodiment 100 of the disclosed system that includes an evacuation chamber 110, a cooling system 120 that includes condensers 122, 128, and 134, a recirculation system 140 that includes a blower 142 and a heat exchanger 152, and a vacuum inlet 161 which is connected to a vacuum pump (not shown).

FIG. 2 shows an exploded view of the evacuation chamber 110 of the embodiment 100 shown in FIG. 1. The evacuation chamber 110 includes a product holding chamber 111, heating elements 112, and insulation 113 encased within an outer shell 114 and sealed with a seal 115. A pressure sensor port 116 is also included. An inlet 117 that allows a circulating vapor stream to enter the evacuation chamber from the recirculation system and an outlet 118 that directs the vapor stream toward the cooling system are also depicted.

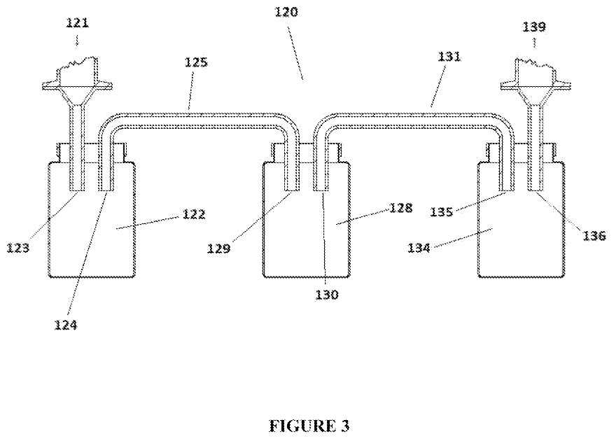

FIG. 3 shows an exploded view of the cooling system 120 of the embodiment 100 shown in FIG. 1, including condensers 122, 128, and 134. The vapor stream 121 enters the cooling system 120 from the evacuation chamber 110 via an inlet. The vapor stream includes a carrier gas that is saturated or substantially saturated with target compounds. The primary condenser 122 includes an inlet valve 123 and an outlet valve 124 to regulate the flow of the vapor stream into and out of the primary condenser 122. When the outlet valve 124 is open, the vapor stream exits the primary condenser 122 via duct 125 and flows toward the secondary condenser 128. The secondary condenser 128 also includes an inlet valve 129 and an outlet valve 130 to regulate the flow of the vapor stream. When the outlet valve 130 is open, the vapor stream exits the secondary condenser 128 via duct 131 and flows toward the tertiary condenser 134. The tertiary condenser 134 also includes an inlet valve 135 and an outlet valve 136 to regulate the flow of the vapor stream. When the outlet valve 136 is open, the vapor stream exits the tertiary condenser 134 via an outlet and flows into the recirculation system as an unsaturated vapor stream 139. The unsaturated vapor stream 139 includes the carrier gas and may also include residual target compounds.

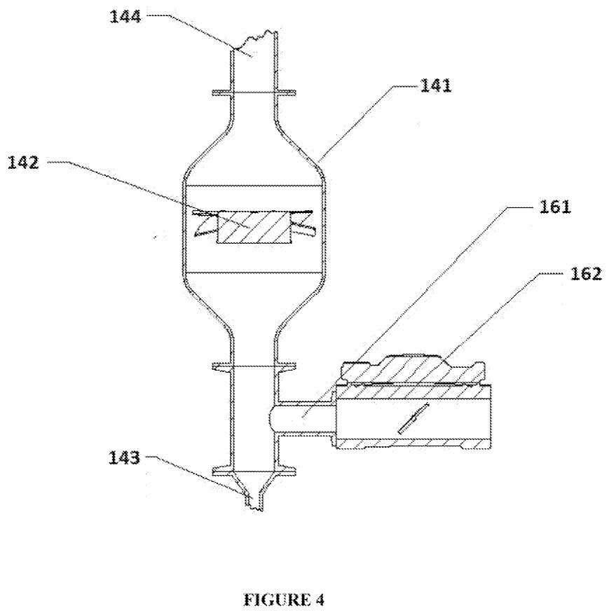

FIG. 4 shows an exploded view of a blower chamber 141 that forms part of the recirculation system 140 of the embodiment 100 shown in FIG. 1. The blower chamber 141 houses a blower 142. The unsaturated vapor stream enters the blower chamber 141 via inlet 143 and exits the blower chamber at a higher flow rate via outlet 144. Vacuum inlet 161 is connected to a vacuum pump (not shown), and a valve 162 allows toggling of the vacuum within the system to further control the vapor stream as desired.

Embodiment 100 shows the blower chamber positioned such that the unsaturated vapor stream enters the blower chamber after it exits the cooling chamber. In alternate embodiments, the blower chamber may be situated between the evacuation chamber and the cooling system, such that one or more blowers in the blower chamber cause the saturated vapor stream that exits the evacuation chamber at a given flow rate to enter the cooling system at a higher flow rate. Multiple blower chambers may also be used if and as appropriate for a given application.

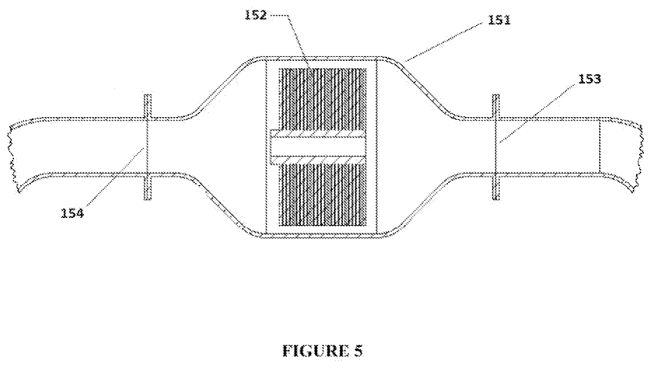

FIG. 5 shows an exploded view of a heat exchange chamber 151 that forms part of the recirculation system 140 of the embodiment 100 shown in FIG. 1. The heat exchange chamber 151 houses a heat exchanger 152. Inlet 153 and outlet 154 valves control the flow of the vapor stream into and out of the heat exchange chamber. The heat exchanger 152 heats the unsaturated vapor stream prior to recirculation of the unsaturated vapor stream into the evacuation chamber 110.

The previous description of the disclosed embodiments is provided to enable any person skilled in the art to make or use the invention disclosed herein. Although the various inventive aspects are disclosed in the context of certain illustrated embodiments, implementations, and examples, it should be understood by those skilled in the art that the invention extends beyond the specifically disclosed embodiments to other alternative embodiments and/or uses of the invention and obvious modifications and equivalents thereof. In addition, while a number of variations of various inventive aspects have been shown and described in detail, other modifications that are within their scope will be readily apparent to those skilled in the art based upon reviewing this disclosure. It should be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. The generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Further, any range of numbers recited above describing or claiming various aspects of the invention, such as ranges that represent a particular set of properties, units of measure, conditions, physical states, or percentages, is intended to literally incorporate any number falling within such range, including any subset of numbers or ranges subsumed within any range so recited. The terms “about” and “approximately” when used as modifiers are intended to convey that the numbers and ranges disclosed herein may be flexible as understood by ordinarily skilled artisans and that practice of the disclosed invention by ordinarily skilled artisans using properties that are outside of a literal range will achieve the desired result.

Each of the foregoing and various aspects, together with those summarized above or otherwise disclosed herein, including the figures, may be combined without limitation to form claims for a device, apparatus, system, method of manufacture, and/or method of use.

All references cited herein are hereby expressly incorporated by reference.

What is claimed is:

1. A method of direct extraction from plant matter comprising the following steps:
introducing plant matter that includes one or more target compounds into an evacuation chamber;
reducing the pressure within the evacuation chamber using a vacuum system to extract one or more of the target compounds from the plant matter and thereby yield one or more vapor phase target compounds;
introducing a carrier gas into the evacuation chamber to generate a vapor stream that includes the carrier gas and the vapor phase target compounds;
transferring the vapor stream from the evacuation chamber into a cooling system; and
condensing one or more of the vapor phase target compounds to yield one or more condensed target compounds.
